(19) United States
(12) Patent Application Publication
(10) Pub. No.: US 2016/0012848 A1
(43) Pub. Date: Jan. 14, 2016

(54) AUDIO ENHANCEMENT PROCESSING SYSTEM

(71) Applicants: Lawrence G. Ryckman, Scottsdale, AZ (US); Sheldon G. Yakus, Minden, NV (US); Ari Blitz, Encino, CA (US)

(72) Inventors: Lawrence G. Ryckman, Scottsdale, AZ (US); Sheldon G. Yakus, Minden, NV (US); Ari Blitz, Encino, CA (US)

(21) Appl. No.: 14/327,911

(22) Filed: Jul. 10, 2014

(51) Int. Cl. G11B 20/10; G06Q 30/06

(52) U.S. Cl. CPC G11B 20/10527; G06Q 30/06; G11B 2020/10555; G11B 2020/10564; G11B 2020/10574

(57) ABSTRACT

The present invention provides an audio enhancement system which is achieved by processing a duplicate of a recording or audio file and creating therefrom at least two identical secondary signals or two layers. One of the layers is the duplicated original and the other being an exact duplicate of that duplicated original. The enhanced audio files or recordings are used to enable the owner of the original audio file to purchase the enhanced audio. The user is enabled by the present system to compare the enhanced duplicate to the original to determine whether or not to purchase the enhanced audio.

### CROSS-REFERENCE TO RELATED APPLICATION

This application is a completion application of copending U.S. Provisional Application Ser. No. 61/844,623, filed Jul. 10, 2013 for “Audio Enhancement Processing System” and is related to the subject matter of copending U.S. patent application Ser. No. 12/807,361 for “Audio Remastering System”, the entire disclosures of which, including claims and drawings, are hereby incorporated by reference.

### BACKGROUND OF THE INVENTION

1. Field of the Invention

The present invention concerns audio enhancement systems. More particularly, the present invention concerns the re-mastering of audio file. Even more particularly, the present invention relates to the re-mastering and audio enhancement of third-party audio file.

2. Prior Art

In co-pending U.S. patent application Ser. No. 12/807,361 filed Sep. 2, 2010, for “Audio Remastering System”, the disclosure which is hereby incorporated by reference there is disclosed a system for re-mastering audio media. The system described therein essentially comprises creating secondary signals or layers from an “original”, i.e. user owned, possessed or licensed, audio recording and “processing” these secondary signals through various electronic devices including limiters, compressors, equalizers, etc., at substantially the same time but at different frequencies. When this treatment of the secondary signals is completed, the signals are merged and the resulting output provides an enhanced sound both in volume and in clarity.

However, the system described therein fails to address the modern day economic and electronic world where users of these systems do not want to acquire an enhanced audio recording without first previewing the results and at the same time being able to order or acquire the enhanced recording from a home computer or the like.

As disclosed hereinafter the present invention addresses these issues.

### SUMMARY OF THE INVENTION

In a first aspect hereof, the present invention provides an audio enhancement system which is achieved by processing a duplicate of a recording or audio file and creating therefrom at least two identical secondary signals or two layers. One of the layers being the duplicated original and the other being an exact duplicate of that duplicated original.

Layers are processed that substantially in the same amount of time and at the same time through selected processing at selected frequencies. The signals are then layered in a final phase where they are processed together at a multi-staged process and outputted therefrom.

In a second aspect hereof, the enhanced audio files or recordings are used to enable the owner of the original audio file to purchase the enhanced audio. The user is enabled by the present system to compare the enhanced duplicate to the original to determine whether or not to purchase the enhanced audio.

The present invention further enables the user to have the audio file processed by the service provider or to provide it to an intermediary which then submits it or transmits the original audio to the service provider.

For a more complete understanding of the present invention, reference is made to the following detailed description and accompanying drawing. In the drawing like referenced characters refer to like parts throughout the several views in which:

### BRIEF DESCRIPTION OF THE DRAWING

FIG. 1 is a flowchart showing an embodiment of an audio enhancement processing system in accordance herewith;

FIG. 2 is a second embodiment of an audio enhancement processing in accordance herewith; and.

FIG. 3 is a flowchart showing a method for audio enhancement having a third party interposed the user and a service provider.

### DESCRIPTION OF THE INVENTION

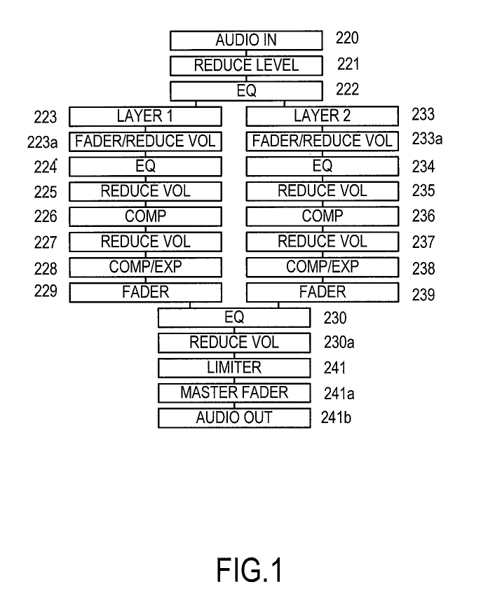

With reference to FIG. 1, according to a first aspect of the present invention, generally, audio enhancement is achieved by taking a duplicate of a recording or audio file and creating at least two identical secondary signals or layers, one being a duplicate of the original and, the other, an exact duplicate of the duplicated original. This is achieved by taking the original signal and after reducing its volume, splitting it into the two signals as an output from an equalizer which is at a selected frequency. The frequencies of each layer can be the same or different from each other.

Thereafter, the layers are processed by passing them through preselected electronic equipment, e.g. plug-ins and/or outboard gear. As described in the co-pending application, the volumes are initially lowered. Then, after each signal is processed, they are layered, one atop the other, and passed through an equalizer, a limiter and a master fader and, then, outputted from there. The enhanced audio is used to provide the owner of the original recording with an enhanced copy of same as described above.

More particularly and in accordance with the present invention, a system for the owner or provider an audio recording or file an enhanced copy thereof which, generally, comprises:
(a) uploading an original audio recording provided by a potential purchaser or user;
(b) preparing a duplicate or copy of the original recording;
(c) enhancing the sound of the duplicated original; and
(d) transmitting at least a portion of the enhanced duplicate to the user to enable the user to determine whether or not to purchase the enhanced duplicate.

By enabling the user to compare the enhanced duplicate to the original, it permits the user to determine whether or not to purchase the enhanced duplicate.

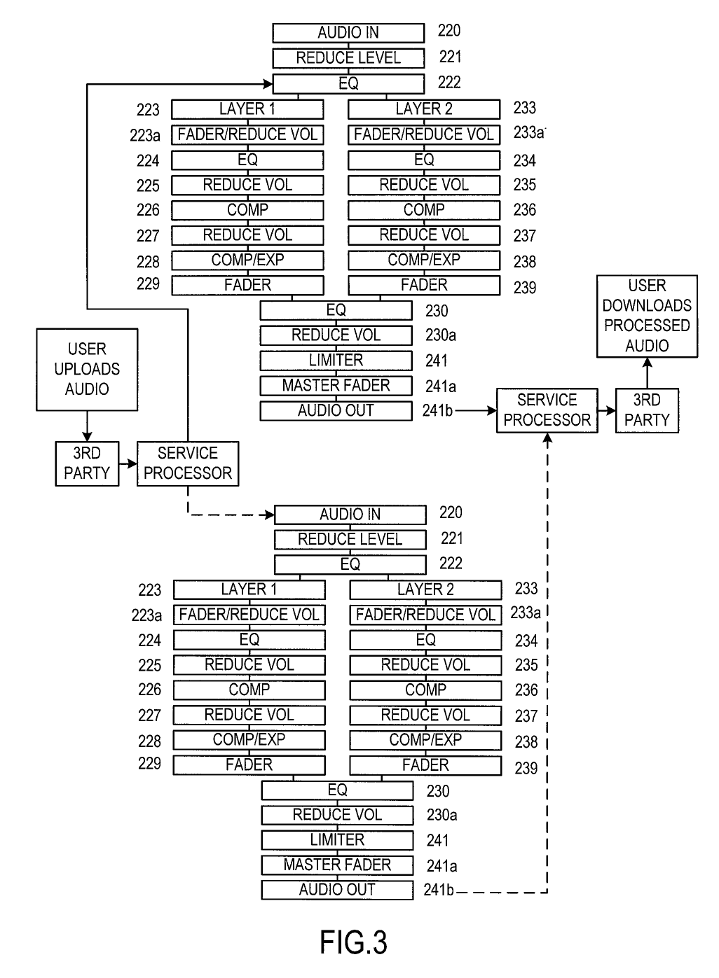

Referring, again to FIGS. 1 and 3, according to a first embodiment hereof, in practicing the present invention the initial step occurs when the potential purchaser or user provides an “original” or initial audio recording or file to a service provider i.e., an audio enhancement service provider. The uploading can occur in a multitude of ways. Preferably, it is a digital sound which is uploaded online. Thus, a CD, MP3, DVD, wave, or AIFF and the like is typically used to create an audio file which is sent to the service provider. It is possible to use an analog signal such as from a vinyl record, or other analog audio media. Here it can be directly mailed to the service provider or can be re-recorded in a digital format and then uploaded as an audio file and then sent to the service provider.

Regardless of the medium on which the audio is recorded, once the original recording is obtained by the service provider a duplicate of that original recording is ordinarily prepared, but not necessary, as discussed below.

The duplicate is prepared by any one of various means. Ordinarily, it is received by the service provider in digitized form, for example, as a CD. If not received in a digitized format, the service provider can digitize the audio recording and therefrom prepare the duplicate. Regardless of how the digitized sound is received, once digitized, the duplicate is enhanced by the enhancement process described below.

As shown in FIG. 1, the copied or duplicated audio signal 220 is processed at 221. Typically, the level is lowered about 8 to 16 dB. A standard volume control is utilized. Alternatively, the signal volume may be reduced at any point in the enhancement process, i.e. when premastering, mastering or re-mastering.

Initially, an equalizer 222 filters out any unwanted frequencies in the duplicate. The output from the equalizer is split into secondary signals or layers. In FIG. 1, this is shown as Layer 1 at 223 and Layer 2 at 233. Frequencies in the range of 125 to 400 cycles per second can be reduced to any desired levels or volume. Any subsequent layers will be affected by this reduction. The use of the equalizer can, if desired, be eliminated, but has been found important in facilitating processing of the signal during subsequent processing in each of the layers 223, 233.

Although not shown in the drawing, if desired more than two layers or signals can be produced such as Layer 3, Layer 4, etc. which can be processed according to the manner shown in FIG. 1

During the processing of Layer 1 denoted at 223, Layer 1 is first reduced in volume by fader 223a and is, then, processed by equalizer 224; reduced in volume at 225; compressed by compressor 226; reduced in volume, again, at 227; processed by compressor/expander 228; has its volume adjusted at 229; processed by equalizer 230; reduced in volume, again at 230a; and, then, processed by limiter 241 and sent to the output through master fader 241a and output 241b.

Layer 2, denoted at 233, is processed in the same manner as Layer 1 processing and, therefore, Layer 2 is first reduced in volume by fader 233a; processed by equalizer 234; then reduced in volume at 235; processed by compressor 236; reduced in volume at 237; processed by compressor/expander 238; adjusted in volume at 239. Layers 1 and 2 are layered and processed at equalizer 230; reduced in volume 230a; processed by limiter 241 and sent to the output through a master fader 241a and outputted at 241b.

As noted, Layers 1 and 2 are layered at equalizer 230 and then processed together beginning at equalizer 230.

Synchronization of the processing of all layers is important. The time required for each layer to pass through its respective processing is substantially equivalent so that each layer or signal takes substantially the same amount of time to pass through its processing and reach limiter 241 and pass through master fader 241a and be outputted is at 241a.

The signals 223, 233 can be equalized in loudness, but in most cases, Layer 1 is usually louder than Layer 2. For example, Layer 1 can have its bass minimized while emphasizing and processing higher frequencies. Layer 2 can have its higher frequencies minimized while emphasizing bass frequencies or vice versa.

Similarly, If the bass frequencies in the original audio signal are weak, Layer 2 processing can increase the loudness of the bass frequencies so that when the processed signals are joined at equalizer 230 and passed through the limiter 241, master fader 241a and output 241b, the resulting audio signal increases a bass component with a greater volume and presence than is the case in the original audio signal or vice versa.

Layer 1 and Layer 2, each, ordinarily, focuses on a band of frequencies that is different from any band of frequencies focused in the other layer. The frequencies that are not being focused on in one layer are being focused on in another layer and complement each other.

After enhancement, the dynamic range appears to be retained.

When a compressor such as at 226, 236, is utilized, the threshold setting is typically adjusted to the user's desires.

It should be noted and although not shown in the drawing, an instrumental track, or portions of an instrumental track, may be put in the middle by having the left side of the audio split to the left and right, and the right side of the audio split to the left and right, to create monophonic sound in one of the layers.

Preferably, each layer is processed with at least one piece of enhancement equipment. While the processing shown in FIG. 1 is a useful embodiment, in practicing the present invention, it is essential that the signal pass through two pieces of equipment, e.g., compressor/expander and fader, etc. As used herein, the term “multiple pieces of equipment” is intended to include a single piece of electronic equipment which provides one or more multiple functions, e.g. compressing, volume reduction, enhances, equalizing, etc

A limiter can limit selected volume peaks while a compressor can compress most volume peaks.

In general, the particular frequencies that Layer 1 or Layer 2 emphasizes will experience an increase in volume compared to their volume levels when the frequencies first enter the onset of the layering process from the equalizer 222.

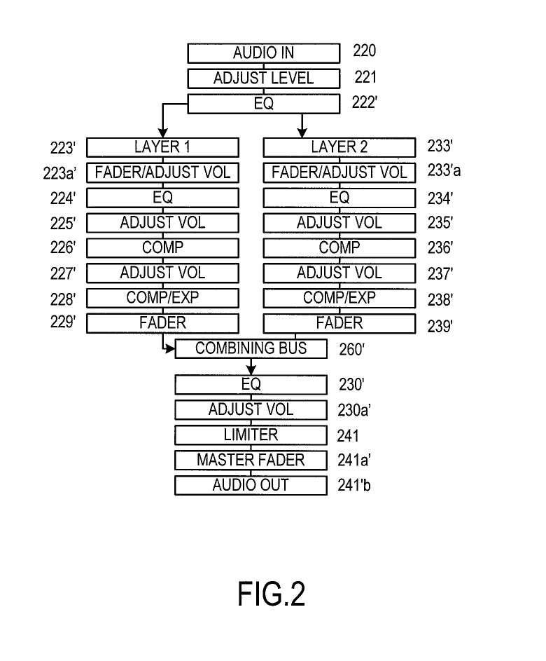

Referring now to FIG. 2, there is shown therein a second embodiment for sound enhancement. As shown therein, the copied or duplicated audio signal 220 is processed at 221′. Typically, the level is adjusted to about 8 to 16 dB. A standard volume control is utilized. Alternatively, the signal volume may be raised or adjusted at any point in the enhancement process, i.e. when premastering, mastering or re-mastering.

Initially, an equalizer 222 either filters out any unwanted frequencies or boosts or adds frequencies in the duplicate. The output from the equalizer is split into at least one copy of the initial or “original” audio file and one secondary signal which is a duplicate of the entire signal of the initial file. The signals are then processed as Layers 1 and 2. In FIG. 2, this is shown as Layer 1 at 223′ and Layer 2 at 233′. Frequencies in the range of 125 to 400 cycles per second can be adjusted to any desired levels or volume. Any subsequent layers will be affected by this reduction. The use of the equalizer can, if desired, be eliminated, but has been found important in facilitating processing of the signal during subsequent processing in each of the layers 223′, 233′.

Although not shown in the drawing, if desired, more than two layers can be produced such as Layer 3, Layer 4, etc. which can be processed according to the manner shown in FIG. 1

During the processing of Layer 1 denoted at 223′, Layer 1 is first adjusted in volume by fader 223′a and is, then, processed by equalizer 224′; adjusted in volume at 225′; compressed by compressor 226′; adjusted in volume, again, at 227′; processed by compressor/expander 228′; has its volume once again adjusted at 229′; processed with Layer 2 by equalizer 230′; adjusted in volume, again, at 230′a; and, then, processed by limiter 241′ and sent to the output through master fader 241a and output 241b.

Layer 2 denoted at 233′ is processed in the same manner as Layer 1 processing and, therefore, Layer 2 is first adjusted in volume by fader 233a; processed by equalizer 234′; then adjusted in volume at 235; processed by compressor 236′; adjusted in volume again at 237′; processed by compressor/expander 238; adjusted in volume again at 239′; layered with Layer 1 at a combining bus 260 prior to entry into the equalizer 230; then the layered signals are processed together by equalizer 230; undergo final adjustment in volume 230′a; processed by limiter 241′; finally processed through master fader 241′a and outputted at 241b.

More particularly, just prior to entry into the equalizer 230, the combining bus 260 is used to layer the incoming signals which, then layered signals, are processed together. The output is thus the layered enhanced audio.

Synchronization of the processing of all layers is important. The time required for each layer to pass through its respective processing is substantially equivalent so that each layer's signal takes substantially the same amount of time to pass through its processing and merge at the combining bus 260 and be outputted as at 241b.

The signals produced by each layer 223, 233 can be equal in loudness, but in most cases, usually Layer 1 223 is louder than Layer 2 233. For example, regardless of which embodiment for enhancement is used, Layer 1 can have its bass minimized while emphasizing and processing higher frequencies. Layer 2 can have its higher frequencies minimized while emphasizing bass frequencies or vice versa.

Similarly, If the bass frequencies in the initial audio signal are weak, Layer 2 processing can increase the loudness of the bass frequencies so that when the processed signals are joined at the combining bus 260 and prior to entry into the equalizer 230, volume adjusted 230a, and passed through the limiter 241, master fader 241a and output 241b, the resulting audio signal, ordinarily or usually, increases a bass component with a greater volume and presence than is the case in the initial audio signal or vice versa.

Layer 1 and Layer 2, each, ordinarily, focuses on a band of frequencies that is different from any band of frequencies focused in the other layer. The frequencies that are not being focused on in one layer are being focused on in another layer and complement each other.

After enhancement, the dynamic range appears to be retained. When a compressor such as at 226, 236, is utilized, the threshold setting is typically adjusted to the user's desires. Preferably, each layer is processed with at least one piece of enhancement equipment. While the processing shown in FIG. 2 is preferred, in practicing the present invention, it is essential that the signal pass through two pieces of equipment, e.g., compressor/expander and fader, etc. As used herein, the term “multiple pieces of equipment” is intended to include a single piece of electronic equipment which provides one or more multiple functions, e.g. compressing, volume reduction, enhances, equalizing, etc.

In general, the particular frequencies that Layer 1 or Layer 2 emphasize will experience an adjustment in volume compared to their volume levels when the signals first enter into the f the present layering process beginning at the equalizer 222.

Regardless of the enhancement processing used, after being processed, at least a portion of the outputted or enhanced duplicate is then sent to the potential purchaser. This enables the user to compare the enhanced sound to the original to determine whether or not he or she desires to obtain the enhanced duplicate.

The at least a portion of the enhanced duplicate can be transmitted to the user by any suitable mode but, preferably, is transmitted electronically online to the purchaser via direct email or through website access.

When using website access the potential purchaser is given a password which enables he or she to access the enhanced duplicate. At that time, the potential purchaser compares the originally transmitted copy and the enhanced duplicate and determines whether he or she wishes to acquire the duplicate. At that time, a purchasing transaction is completed. Once the purchasing transaction is completed the duplicate may be downloaded by the purchaser. At all times the original recording remains in the possession of the user.

Alternatively, the user can set up an account, such as a “Pay Pal” account with the service provider and pay for the transactions in that manner.

The processing and the transaction can be done directly between the user-purchaser and a service provider or can be achieved via a third party.

Referring now to FIG. 3, there is shown an alternate embodiment hereof wherein the process is conducted via the interposition of a third party between the user and service provider. Here, the user's original recording audio file is sent to the third party. Upon receipt by the third party, a notification may be sent to the service provider advising of receipt of an audio recording, along with a duplicate of the original recording being sent simultaneously. Preferably, the third party makes the duplicate and sends the duplicate to the service provider along with any notification.

Upon receipt of the duplicate from the third party the service provider then enhances the duplicate as described above.

At least a portion of the sound that has been enhanced is then sent back to the third party which, in turn, provides it to the user who, then, makes the determination as to whether or not to purchase.

If the user desires to acquire the enhanced duplicate the third party completes the transaction, notifies the service provider who then sends the enhanced duplicate back to the third party.

As with the first embodiment, the original recording stays with the user. The duplicate is transmitted by uploading it and sending it as an audio file to the third party.

Where there is an older recording, such as a vinyl recording, 8 track, tape or the like, it can be played on a suitable device that has an analog output which can then be used to create an audio file which is then transmitted to the third party. Otherwise, it can be mailed or otherwise transmitted to the third party.

In a particularly preferred embodiment hereof, the duplicate which is to be enhanced is processed into multiple “versions”. In other words, it is preprocessed at different enhancement volume levels or equalizer settings to provide at least a first and second version and, preferably, a third version or more.

By using “preprocessing” the user can make a choice as to which enhanced version he or she desires to purchase.

The user is provided with at least portions of each of the versions or the total version from which the purchaser can make the comparisons between the versions and the original and thereafter make his or her selection as to which version he or she wishes to purchase.

In practicing the present invention it is to be understood that at all times any digital original recording remains in the possession of the purchaser.

As with the first embodiment, where vinyl or other prior art audio recordings are involved they can be digitized and provided or may be mailed to directly to the service provider or to the third party, in the manner described above. It should be noted and as indicated above, a duplicate is not necessary to enhance the audio.

It is to be appreciated that the present invention provides an improved method for sound enhancement of audio recordings that enables a user to choose and compare the original to the enhanced versions of the recording.

Having, thus, described the invention, what is claimed is:

1. A system for enhancing the sound of an initial audio file for a user, comprising:
(a) uploading to an audio enhancement server an initial audio file provided by the user;
(b) preparing a duplicate of the initial audio file;
(c) enhancing the sound of the duplicate, and
(d) transmitting at least a portion of the enhanced duplicate to the user to enable the user to determine whether or not to purchase the enhanced duplicate.

2. The system of claim 1 wherein the initial audio recording is enhanced by a process comprising:
(a) reducing the level of the initial audio file;
(b) processing the reduced level duplicate audio file in an equalizer;
(c) thereafter, splitting the duplicated initial audio file into a first layer and second layer;
(d) processing each layer simultaneously by:
(i) first reducing the layer in volume at a fader;
(ii) processing the layer at an equalizer;
(iii) reducing the volume at a fader;
(iv) compressing the layer at a compressor;
(v) reducing the volume, again;
(vi) processing the layer at a compressor/expander;
(vii) adjusting the volume, again;
(viii) processing the volume adjusted layer at an equalizer;
(ix) layering the layers together and thereafter;
(1) reducing the volume of the layered layers;
(2) processing the layered layers at a limiter;
(3) processing the layered layers through a master fader; and
(4) thereafter outputting the enhanced audio file.

3. The system of claim 1 wherein the initial audio recording is enhanced by a process comprising:
(a) dividing, at an equalizer, the inputted duplicated audio file into a first audio signal and a second audio signal, each signal being an exact copy of the inputted duplicated signal;
(b) thereafter processing each of the signals by:
(i) first adjusting the volume at a fader;
(ii) processing the signal at an equalizer;
(iii) adjusting the volume again,
(iv) then compressing the signal at a compressor;
(v) adjusting the volume, again;
(vi) processing the signal at a compressor/expander;
(vii) adjusting the volume a further time;
(viii) layering the signals at a combining bus;
(ix) processing the layered signals together by
(1) passing the signals through an equalizer;
(2) adjusting the volume of the layered signals;
(3) processing the signals at a limiter; and
(4) sending the signals to the output through a master fader; and
(c) then outputting the signals.

4. The process of claim 3 wherein:
the signals are processed at different frequencies.

5. The process of claim 4 further comprising:
transmitting at least a portion of the enhanced audio file to the user.

6. The process of claim 3 wherein the initial audio file is preprocessed at different volume levels to provide at least first and second enhanced audio file versions.

7. The process of claim 1 which further comprises:
(a) transmitting the initial audio file to a third party;
(b) duplicating the file at the third party; and
(c) sending the duplicated file to the audio enhancement server for enhancement.

8. The process of claim 7 wherein the enhanced audio file is transmitted to the user by the audio enhancement server.
